(19) United States
(12) Patent Application Publication
(10) Pub. No.: US 2026/0031570 A1
(43) Pub. Date: Jan. 29, 2026

(54) SELF-ALIGNMENT CONNECTOR

(71) Applicant: HYUNDAI MOBIS CO., LTD., Seoul (KR)

(72) Inventors: Young Jun KIM, Yongin-si (KR); Kwon Il CHO, Yongin-si (KR)

(73) Assignee: HYUNDAI MOBIS CO., LTD., Seoul (KR)

(21) Appl. No.: 18/976,915

(22) Filed: Dec. 11, 2024

(30) Foreign Application Priority Data
Jul. 23, 2024 (KR) 10-2024-0097397

(51) Int. Cl. H01R 13/631

(52) U.S. Cl. CPC H01R 13/631

(57) ABSTRACT

A self-alignment connector, and a self-alignment connector for a vehicle are provided. The self-alignment connector includes a first connector having a pin terminal provided therein, and a second connector having a socket terminal provided therein, into which the pin terminal is inserted. The first connector includes a housing accommodating the pin terminal therein, an accommodation space formed inside the housing and accommodating the second connector in a first direction, a pair of position correction guides formed on at least two sides of the housing and extending in the first direction, and a prevention guide formed at a rear of the housing and extending in a second direction perpendicular to the first direction.

### CROSS-REFERENCE TO RELATED APPLICATION(S)

This application claims the benefit under 35 USC § 119 of Korean Patent Application No. 10-2024-0097397, filed on Jul. 23, 2024, in the Korean Intellectual Property Office, the entire disclosure of which is hereby incorporated by reference for all purposes.

### BACKGROUND

### 1. Field

The disclosure relates to a self-alignment connector, and more particularly, to a self-alignment connector which facilitates coupling and separation between connectors.

### 2. Description of the Related Art

In general, a connector is a device that electrically connects a power source and a device, a device and a device, and internal units of a device. This connector includes a pair of connectors connectable to each other, that is, a plug connector and a receptacle connector. Terminals for transmitting current and signals are provided inside the plug connector and the receptacle connector.

However, a conventional connector assembly has limitations in significantly improving efficiency and workability because an operator needs to check it visually or tactilely before connecting.

Moreover, the conventional connector assembly suffers from concentration of stress on a specific position of a positioning correction arm during a process of connecting the plug connector and the receptacle connector.

As such, when stress is concentrated at a specific position of the position correction arm during connection between the plug connector and the receptacle connector, this may reduce the strength of a corresponding portion, and in a worse case, cause cracks or damage.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

Accordingly, the disclosure is directed to a self-alignment connector that substantially obviates one or more problems due to limitations and disadvantages of the related art.

An aspect of the disclosure is to provide a self-alignment connector that may prevent cracks or breakage at a specific position by distributing stress applied to a specific connector during coupling between connectors.

Another aspect of the disclosure is to provide a self-alignment connector that may improve coupling stability during coupling between connectors.

The objects to be achieved by the disclosure are not limited to what has been particularly described hereinabove and other objects not described herein will be more clearly understood by persons skilled in the art from the following detailed description.

In a general aspect of the disclosure, a self-alignment connector includes: a first connector having a pin terminal provided therein; and a second connector having a socket terminal provided therein, into which the pin terminal is inserted, wherein the first connector includes: a housing accommodating the pin terminal therein; an accommodation space formed inside the housing and configured to accommodate the second connector in a first direction; a pair of position correction guides formed on at least two sides of the housing and configured to extend in the first direction; and a prevention guide formed at a rear of the housing and configured to extend in a second direction perpendicular to the first direction.

The pair of position correction guides may include: a first curved portion including: one end that meets the at least two sides of the housing; and another end bent in the first direction; and a second curved portion including: one end that meets the other end of the first curved portion; and another end that meets the rear of the housing, and is formed in an S shape.

The pair of position correction guides may further include an extension portion that protrudes from the first curved portion toward both sides of the housing, wherein an end of the extension portion may be spaced apart from the at least two sides of the housing.

The extension portion may be configured to be spaced apart from the second curved portion.

The extension portion may be configured to be inclined toward a front of the housing.

The pair of position correction guides may further include a slot configured to extend from the first curved portion to the second curved portion.

The prevention guide may include a pair of prevention guides, wherein the pair of prevention guides may be configured to be spaced apart from top and bottom ends of the housing, respectively.

Tension of a first prevention guide located on an upper side may be formed to be greater than tension of a second prevention guide located on a lower side.

The first connector may further include a fastening guide formed at a front of the housing and having a width increasing in a forward direction, wherein the second connector may be accommodated in the accommodation space along the fastening guide.

The fastening guide may have a square cross-section.

The second connector may include: a housing configured to accommodate the socket terminal therein; a protrusion protruding from a front end of the housing and configured to form a mounting space in which the socket terminal is mounted; and a pair of position correction guides formed on the at least two sides of the housing and configured to extend in a direction opposite to the first direction.

The pair of position correction guides may include an extension portion having: one end that meets the at least two sides of the housing; and another end extending in the first direction; and a bent portion having: one end configured to meet the other end of the extension portion; and another end bent to meet a rear of the housing.

The pair of position correction guides may include: a first extension portion and a first bent portion formed on a top side of the housing; and a second extension portion and a second bend portion formed on a bottom side of the housing, respectively.

The position correction guides may be configured to: correct a fastening position of the second connector when the first connector and the second connector are fastened with each other; and distribute a load generated in the first connector.

The position correction guides may include: a first extension portion and a first bent portion formed on a top side of the housing; and a second extension portion and a second bend portion formed on a bottom side of the housing, respectively.

The extensions of the position correction guides may be configured to prevent movement of the housing in the forward/backward direction.

In response to a load being applied to the first connector in the up-down direction due to a movement of the second connector in the forward and backward directions, the prevention guide is configured to prevent the movement of the first connector in the up-down direction.

In another general aspect of the disclosure, a self-alignment connector for a vehicle, includes: a first connector including a pin terminal; and a second connector including a socket terminal, the pin terminal insertable in the socket terminal, wherein the first connector further includes: a housing for accommodating the pin terminal, the housing including an accommodation space formed therein and configured to accommodate the second connector in a first direction; position correction guides formed on at least two sides of the housing and configured to extend in the first direction; and a prevention guide formed at a rear of the housing and configured to extend in a second direction perpendicular to the first direction, wherein the prevention guide and the position correction guides are configured to correctly align a fastening direction between the first connector and the second connector.

According to embodiments, a self-alignment connector is provided, which may prevent cracks or breakage at a specific position by distributing stress applied to a specific connector during coupling between connectors, thereby enabling an operator to easily couple/fasten the connectors.

According to embodiments, a self-alignment connector is provided, which may improve coupling stability during coupling between connectors, thereby enabling an operator to easily couple/fasten the connectors.

The effects that are achievable by the disclosure are not limited to what has been particularly described hereinabove and other advantages not described herein will be more clearly understood by persons skilled in the art from the following description.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating a self-alignment connector according to embodiments;

FIG. 2 is an exploded view illustrating a self-alignment connector according to embodiments;

FIGS. 3 to 5 are diagrams illustrating a first connector in a self-alignment connector according to embodiments;

FIG. 6 is a diagram illustrating a prevention guide of a first connector in a self-alignment connector according to embodiments;

FIGS. 7 to 9 are diagrams illustrating an example of coupling a second connector to a first connector in a self-alignment connector according to embodiments; and

FIGS. 10 and 11 are diagrams illustrating a second connector in a self-alignment connector according to embodiments.

### DETAILED DESCRIPTION

Embodiments disclosed herein will be described in detail with reference to the attached drawings. Through the drawings, like reference numerals denote the same or similar components and a redundant description of the components will be avoided.

The suffixes “module” and “unit” used for components in the following description are given or used interchangeably only for the convenience of description, and do not have distinct meanings or roles in themselves. In addition, when describing the embodiments disclosed herein, a detailed description of a related known technology will be omitted lest it should obscure the subject matter of the embodiments.

In addition, the attached drawings are only intended to facilitate easy understanding of the embodiments disclosed herein, and do not limit the technical ideas disclosed in the specification, which should be understood to include all modifications, equivalents, or substitutes included in the scope of the disclosure.

Terms including ordinal numbers such as first, second may be used to describe various components. However, the components are not limited by the terms. The above terms are used only for the purpose of distinguishing one component from another.

When it is said that a component is “coupled” or “connected” to another component, the components should be understood as directly connected or connected with a third component in between. On the other hand, when it is said that a component is “directly coupled” or “directly connected” to another component, it should be understood that there are no other components in between.

A singular expression includes plural referents unless the context clearly indicates otherwise.

In this application, the term “comprise” or “have (has)” is intended to specify the presence of a feature, number, step, operation, component, part, or combination thereof described in the specification, not excluding the possibility of the presence or addition of one or more other features, numbers, steps, operations, components, parts, or combinations thereof.

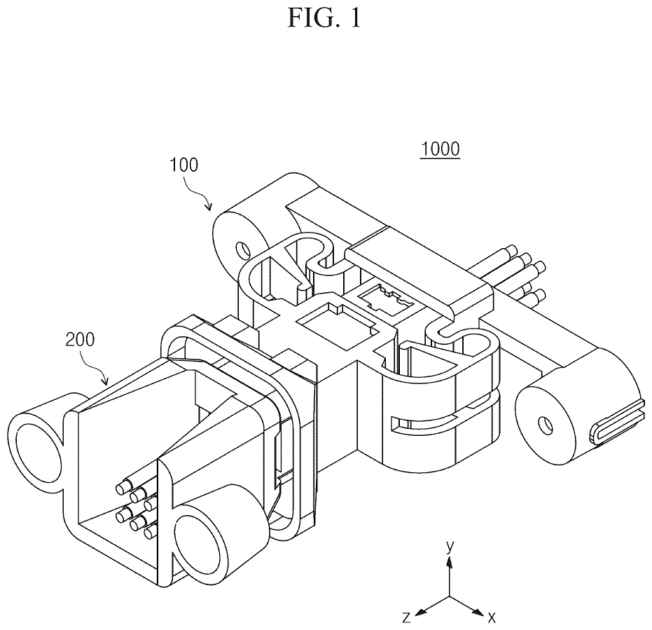

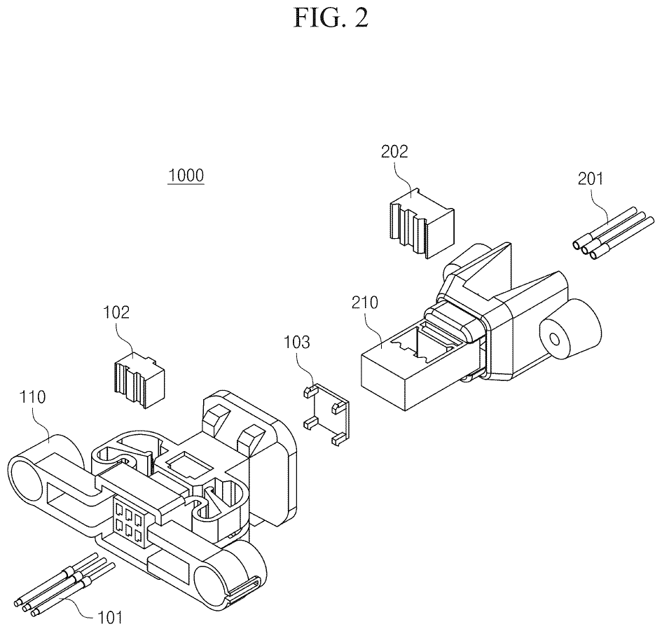

FIG. 1 is a diagram illustrating a self-alignment connector according to embodiments. FIG. 2 is an exploded view illustrating the self-alignment connector according to embodiments.

More specifically, FIG. 1 is a diagram illustrating a state in which a second connector 200 is fastened with a first connector 100.

A self-alignment connector 1000 illustrated in FIG. 2 corresponds to a self-alignment connector 1000 illustrated in FIG. 1.

The self-alignment connector 1000 according to the embodiments will be described below with the appreciation that a left-right direction is an x-axis direction, an up-down direction is a y-axis direction, and a forward or backward direction is a z-axis direction.

Referring to FIG. 1 and FIG. 2, the self-alignment connector 1000 according to the embodiments may include the first connector 100 and the second connector 200.

The self-alignment connector 1000 may correspond to a connector which is installed in a vehicle lamp assembly or the like and transmits current and signals. That is, the first connector 100 may be installed on the side of a vehicle lamp lens (not shown) and correspond to a type of male connector. Alternatively, the second connector 200 may be installed on the side of a vehicle lamp housing (not shown) and correspond to a type of female connector.

The first connector 100 may include a housing 110 forming the exterior thereof and a pin terminal 101 installed inside the housing 110. A locking device 102 may be provided inside the housing 110 to prevent the pin terminal 101 from falling out after it is installed.

Similar to the first connector 100, the second connector 200 may include a housing 210 forming the exterior thereof and a socket terminal 201 installed inside the housing 210. Similarly, a locking device 202 may be provided inside the housing 210 to prevent the socket terminal 201 from falling out after it is installed.

That is, the first connector 100 and the second connector 200 may be fastened with each other by inserting the pin terminal 101 into the socket terminal 201. To prevent deformation of the pin terminal 101 that occurs when the pin terminal 101 is inserted into the socket terminal 201, the housing 110 of the first connector 100 may include a plate 103. The plate 103 may be formed in a plate shape having a certain strength in order to prevent the deformation of the pin terminal 101 that occurs when the pin terminal 101 is inserted into the socket terminal 201. Further, the plate 103 may be formed such that a protruding portion of the pin terminal 101 passes through it and an insertion portion of the socket terminal 201 does not pass through it.

A conventional connector assembly has a problem in that a first connector and a second connector are not properly fastened with each other due to an incorrect fastening position or the like during fastening between the connectors. Moreover, the conventional connector assembly suffers from cracks or breakage due to a load applied to the first connector or the second connector during fastening between the connectors.

Therefore, the self-alignment connector 1000 according to the embodiments is effective in that the first connector 100 is provided with a position correction guide 130 and a prevention guide 140 to solve the above-mentioned problem. The first connector 100 will be described below in more detail.

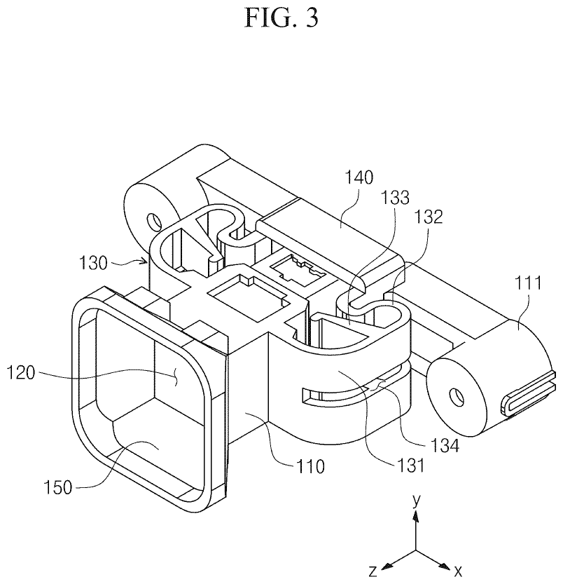

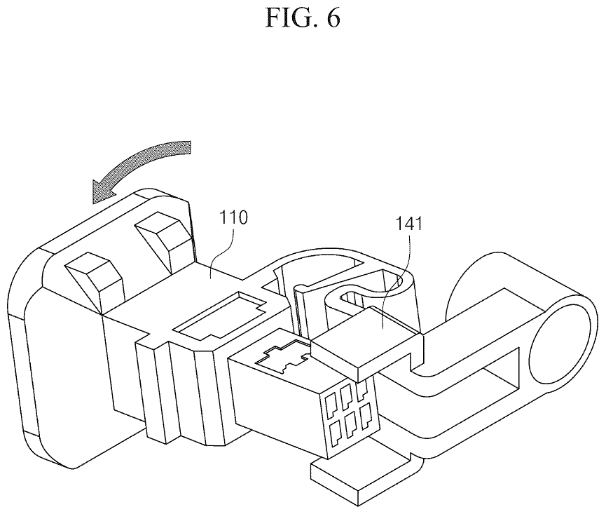

FIGS. 3 to 5 are diagrams illustrating the first connector in the self-alignment connector according to the embodiments. FIG. 6 is a diagram illustrating the prevention guide of the first connector in the self-alignment connector according to the embodiments.

Referring to FIGS. 3 to 5, the first connector 100 in the self-alignment connector 1000 according to the embodiments may include the housing 110, an accommodation space 120, the position correction guide 130, the prevention guide 140, and a fastening guide 150.

The housing 110, which is configured to form the exterior of the first connector 100 as described in FIGS. 1 and 2, may accommodate the pin terminal 101 therein. A fastening portion 111 may be formed at the rear of the housing 110. The first connector 100 may be fastened with the vehicle lamp lens (not shown) through the fastening portion 111.

The accommodation space 120 may be formed inside the housing 110 and accommodate the second connector 200 in a first direction. That is, the accommodation space 120 may accommodate the second connector 200 inserted in the first direction (−z-axis direction). The second connector 200 may be inserted in the first direction and accommodated in the accommodation space 120. More specifically, when the second connector 200 is accommodated in the accommodation space 120, the pin terminal 101 provided in the first connector 200 may be fastened with the socket terminal 201 provided in the second connector 200.

Position correction guides 130 may be formed on both sides of the housing 110, extend in the first direction, and be in a pair. That is, a position correction guide 130 may be formed on each side of the housing 110.

Each of the position correction guides 130 may include a first curved portion 131, a second curved portion 132, an extension portion 133, and a slot 134.

The first curved portions 131 may be formed to have one ends meeting both sides of the housing 110 and the other ends bent in the first direction. That is, the first curved portions 131 may be formed to extend from the housing 110 and bent toward the rear of the housing 110.

The second curved portions 132 may be formed to have one ends meeting the other ends of the first curved portion 131 and the other ends meeting the rear of the housing 110. In addition, the second curved portions 132 may be formed in an S shape. That is, the second curved portions 132 may be extended from the other ends of the first curved portions 131 and bent in an S shape to meet the rear of the housing 110.

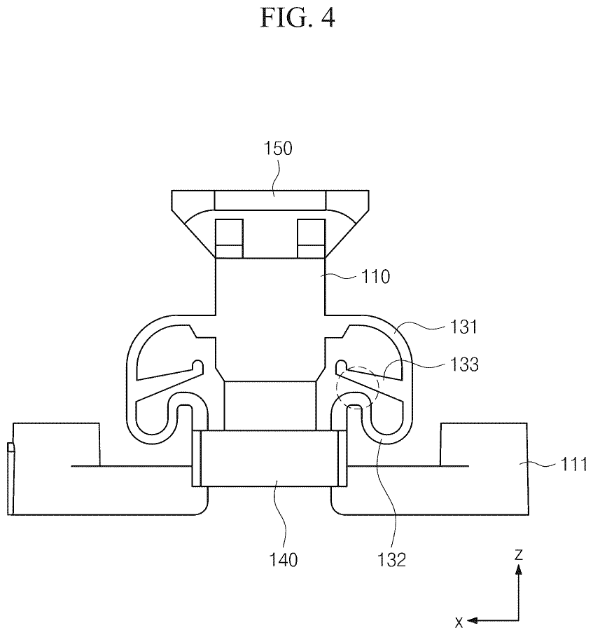

Referring to FIGS. 3 and 4, preferably, the second curved portions 132 may be first bent in the forward direction of the housing 110 (in the +z-axis direction) and then bent in the backward direction of the housing 110 (in the −z-axis direction).

The extension portions 133 may be formed to protrude from the first curved portions 131 toward both sides of the housing 110. That is, the extension portions 133 may extend from the middles of the first curved portions 131 and protrude and extend toward both sides of the housing 110 (in +x-axis and −x-axis directions).

In addition, the extension portions 133 may be formed to be inclined in the forward direction of the housing 110. In addition, the extension portions 133 may be formed to be spaced apart from the second curved portions 132.

The slots 134 may be formed to extend from the first curved portions 131 to the second curved portions 132.

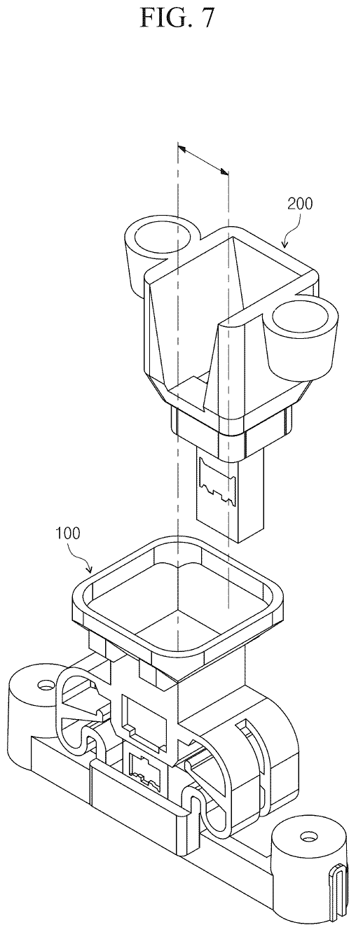

The position correction guides 130 may correct a fastening position of the second connector 200, when the second connector 200 and the first connector 100 are fastened with each other, and at the same time, may distribute a load generated in the first connector 100. In particular, the extensions 133 of the position correction guides 130 may prevent movement of the housing 110 in the forward/backward direction (+/−z-axis direction). A detailed description thereof will be given with reference to FIGS. 7 to 9.

The prevention guide 140 may be formed at the rear of the housing 110 and extend in a second direction perpendicular to the first direction. That is, the prevention guide 140 may be formed at the rear of the housing 110 and formed in a plate shape that extends long in the left-right direction of the first connector 100 (in the +/−x-axis direction).

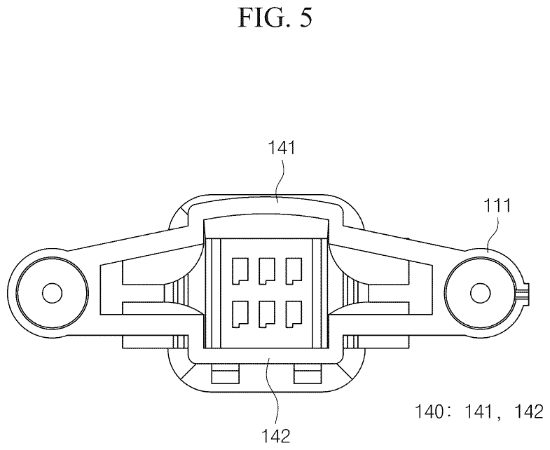

Referring to FIG. 5, the prevention guide 140 may be formed as a pair. More specifically, the prevention guide 140 may include an upper prevention guide 141 formed spaced apart from a top end of the housing 110 and a lower prevention guide 142 formed spaced apart from a lower end of the housing 110.

In particular, the prevention guide 140 may meet the fastening portion 111 located at the rear of the housing 110. That is, the prevention guide 140 may be located apart from the housing 110 and meet the fastening portion 111 formed to extend to the rear of the housing 110.

Tension of the upper prevention guide 141 may be formed to be greater than tension of the lower prevention guide 142. That is, the tension of the upper prevention guide 141 may be formed to be higher than the tension of the lower prevention guide 142.

As the prevention guide 140 is formed to be spaced apart from the top or bottom of the housing 110, excessive twisting that occurs in the first connector 100 may be prevented during fastening between the second connector 200 and the first connector 100. That is, as illustrated in FIG. 6, when the second connector 200 and the first connector 100 are fastened, a twisting phenomenon may occur in a neck portion of the first connector 100, which may result in excessive movement of the housing 110 of the first connector 100 in the up-down direction (+/−y-axis direction).

Therefore, the prevention guide 140 in the self-alignment connector 1000 according to embodiments may be spaced apart from the top and bottom of the housing 110, thereby allowing a certain degree of vertical movement of the housing 110, but preventing excessive vertical movement of the housing 110.

The fastening guide 150 may be formed at the front of the housing 110 and have a width increasing in the forward direction. More specifically, as illustrated in FIG. 3, four fastening guides 150 may be formed at respective corners forming front end surfaces of the housing 110. Each of the fastening guides 150 may have an angle shape bent along a corner of a front end surface of the housing 110, and an inner wall in a tapered shape reduced toward the accommodation space 120.

As the fastening guides 150 are formed in a shape in which their inner walls are reduced toward the accommodation space 120, a coupling/fastening direction may be corrected by the fastening guides 150 even if a coupling/fastening direction of the first connector 100 and the second connector 200 is somewhat misaligned. In particular, because the fastening guides 150 are formed in an angle shape, the coupling direction of the first connector 100 and the second connector 200 may be corrected up and down and left and right.

FIGS. 7 to 9 are diagrams illustrating an example of fastening the second connector with the first connector in the self-alignment connector according to embodiments.

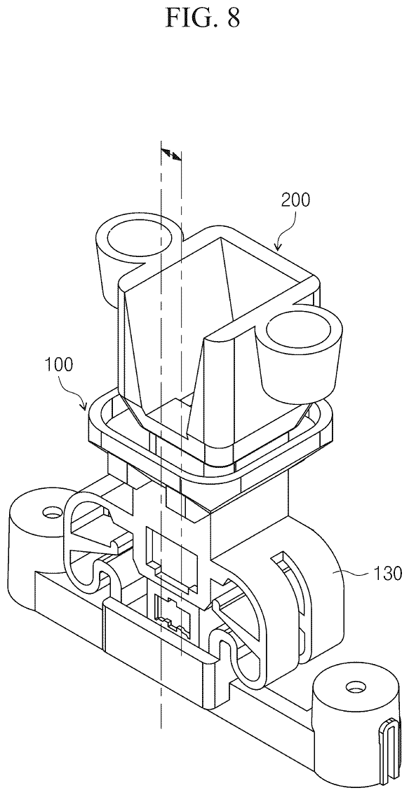

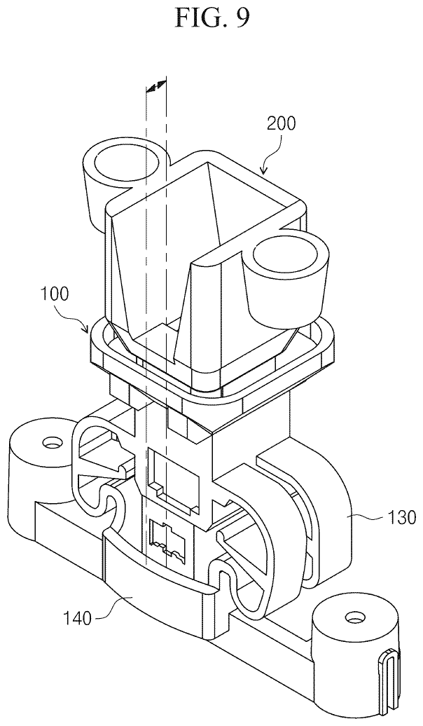

More specifically, FIG. 7 illustrates a state in which the second connector 200 is fastened with the first connector 100 at an incorrect fastening position, FIG. 8 illustrates a state in which the left and right sides of the second connector 200 are corrected by the position correction guides 130, and FIG. 9 illustrates a state in which the front and rear of the second connector 200 are corrected by the position correction guides 130 and the prevention guide 140.

First, as illustrated in FIG. 7, when the second connector 200 and the first connector 100 are fastened, the second connector 200 may be inserted into the first connector 100 at an incorrect fastening position.

As described with reference to FIGS. 3 to 5, when the second connector 200 moves in a direction of coupling with the first connector 100, it may come into contact with the fastening guides 150 formed at the front of the housing 110. The second connector 200 in contact with the fastening guides 150 may move to the left along the inner walls of the fastening guides 150 and the coupling direction may be corrected.

In particular, it may be preferable that the fastening guides 150 have a square cross-section and include four walls. Therefore, regardless of the coupling direction of the second connector 200, the second connector 200 may move upward/downward/left/right along the inner walls of the fastening guides 150 and the coupling direction may be corrected.

Even if the coupling direction is wrong, the coupling direction of the second connector 200 may be corrected by the fastening guides 150, and as a result, the second connector 200 may be fastened with the first connector 100 as illustrated in FIGS. 8 and 9.

Referring to FIG. 8, even if the coupling direction of the second connector 200 is different from an original fastening direction in terms of left and right, the position of the second connector 200 may be automatically corrected by the position correction guides 130.

That is, when the second connector 200 is accommodated in the accommodation space 120 along the fastening guides 150, the position of the second connector 200 may be automatically corrected by a spring tension structure of the position correction guides 130 and a spring tension structure of the prevention guide 140.

Further, when a load is applied to the first connector 100 in the first direction due to movement of the second connector 200 in the first direction, the extension portions 133 of the position correction guides 130 may prevent the movement of the second curved portions 132 of the position correction guides 130 in the forward and backward direction. The position correction guides 130 may correct up to a fastening direction that is different by 6 mm in terms of left and right from the original fastening direction.

Referring to FIG. 9, even if the coupling direction of the second connector 200 is different from the original fastening direction in terms of front and rear, the position of the second connector 200 may be automatically corrected by the position correction guides 130 and the prevention guide 140.

That is, when the second connector 200 is accommodated in the accommodation space 120 along the fastening guides 150, the position of the second connector 200 may be automatically corrected by the spring tension structure of the position correction guides 130 and the spring tension structure of the prevention guide 140.

Further, when a load is applied to the first connector 100 in the up-down direction (+/−y-axis direction) according to the movement of the second connector 200 in the forward and backward directions, the prevention guide 140 may prevent the movement of the first connector 100 in the up-down direction. The prevention guide 140 and the position correction guides 130 may correct a fastening direction different by up to 6 mm from the original fastening direction in terms of front and rear.

Therefore, the self-alignment connector 1000 according to embodiments has the effect of automatically correcting the position of the second connector 200 even if the second connector 200 is fastened in an incorrect coupling direction regardless of the left/right/up/down direction.

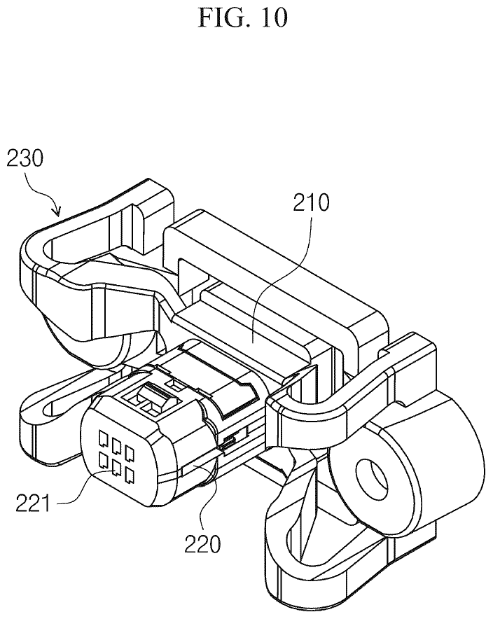

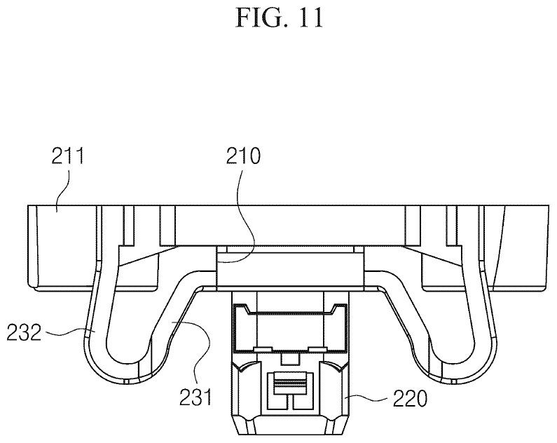

FIGS. 10 and 11 are diagrams illustrating the second connector in the self-alignment connector according to embodiments.

Referring to FIGS. 10 and 11, the second connector 200 in the self-alignment connector 1000 according to embodiments may include the housing 210, a protrusion 220, and a position correction guide 230.

The housing 210, which is configured to form the exterior of the second connector 200 as described with reference to FIGS. 1 and 2, may accommodate the socket terminal 201 therein. A fastening portion 211 may be formed at the rear of the housing 110. The second connector 200 may be installed on the side of the vehicle lamp housing (not shown) through the fastening portion 211.

The protrusion 220 may be formed to protrude from a front end of the housing 210, and a mounting space 221 in which a socket terminal 201 is mounted may be formed. That is, the protrusion 220 may have the socket terminal 201 provided therein, and the protrusion 220 may be inserted into the accommodation space 120 of the first connector 100. More specifically, as the protrusion 220 is accommodated in the accommodation space 120, the pin terminal 101 of the first connector 200 may be fastened with the socket terminal 201 of the second connector 200.

Position correction guides 230 may be formed on both sides of the housing 210 and extend in a direction opposite to the first direction. The position correction guides 230 may be formed in a pair. That is, a position correction guides 230 may be formed on each side of the housing 210.

Each of the position correction guides 230 may include an extension portion 231 and a bent portion 232.

The extension portions 231 may be formed to have one ends meeting both sides of the housing 210 and the other ends extending in the first direction. That is, the extension portions 231 may be formed to extend from the housing 210 in the forward direction of the housing 210.

The bent portions 232 may be formed to have one ends meeting the other ends of the extension 231 and the other ends meeting the rear of the housing 210. That is, the bent portions 232 may be formed to extend from the extension portions 231 and be bent toward the rear of the housing 210.

In particular, the bent portions 232 may meet the fastening portion 211 located at the rear of the housing 210. That is, the bent portions 232 may be formed to be bent toward the rear of the housing 210 and meet the fastening portion 211 formed to extend to the rear of the housing 210.

In addition, the extension portions 231 and the bent portions 232 may be formed in pairs. That is, as illustrated in FIG. 10, a pair of an extension portion 231 and a bent portion 232 may be formed on each of a top side of the housing 210 and a bottom side of the housing 210.

The detailed description of the preferred embodiments of the disclosure disclosed as described above has been provided to enable those skilled in the art to implement and practice the disclosure. While the disclosure has been described above with reference to preferred embodiments thereof, it will be understood by those skilled in the art that various modifications and variations may be made to the disclosure without departing from the scope of the disclosure. For example, those skilled in the art may utilize the individual components described in the above-described embodiments in a manner that combines them with each other.

Accordingly, the disclosure is not intended to be limited to the embodiments disclosed herein, but is intended to have the broadest scope consistent with the principles and novel features disclosed herein.

What is claimed is:

1. A self-alignment connector comprising:
a first connector having a pin terminal provided therein; and
a second connector having a socket terminal provided therein, into which the pin terminal is inserted,
wherein the first connector includes:
a housing accommodating the pin terminal therein;
an accommodation space formed inside the housing and configured to accommodate the second connector in a first direction;
a pair of position correction guides formed on at least two sides of the housing and configured to extend in the first direction; and
a prevention guide formed at a rear of the housing and configured to extend in a second direction perpendicular to the first direction.

2. The self-alignment connector of claim 1, wherein the pair of position correction guides includes:
a first curved portion including:
one end that meets the at least two sides of the housing; and
another end bent in the first direction; and
a second curved portion including:
one end that meets the other end of the first curved portion; and another end that meets the rear of the housing, and is formed in an S shape.

3. The self-alignment connector of claim 2,
wherein the pair of position correction guides further includes an extension portion that protrudes from the first curved portion toward both sides of the housing, and
wherein an end of the extension portion is spaced apart from the at least two sides of the housing.

4. The self-alignment connector of claim 3, wherein the extension portion is configured to be spaced apart from the second curved portion.

5. The self-alignment connector of claim 3, wherein the extension portion is configured to be inclined toward a front of the housing.

6. The self-alignment connector of claim 2, wherein the pair of position correction guides further includes a slot configured to extend from the first curved portion to the second curved portion.

7. The self-alignment connector of claim 1,
wherein the prevention guide includes a pair of prevention guides, and
wherein the pair of prevention guides are configured to be spaced apart from top and bottom ends of the housing, respectively.

8. The self-alignment connector of claim 7, wherein tension of a first prevention guide located on an upper side is formed to be greater than tension of a second prevention guide located on a lower side.

9. The self-alignment connector of claim 1,
wherein the first connector further includes a fastening guide formed at a front of the housing and having a width increasing in a forward direction, and
wherein the second connector is accommodated in the accommodation space along the fastening guide.

10. The self-alignment connector of claim 9, wherein the fastening guide has a square cross-section.

11. The self-alignment connector of claim 1, wherein the second connector includes:
a housing configured to accommodate the socket terminal therein;
a protrusion protruding from a front end of the housing and configured to form a mounting space in which the socket terminal is mounted; and
a pair of position correction guides formed on the at least two sides of the housing and configured to extend in a direction opposite to the first direction.

12. The self-alignment connector of claim 11, wherein the pair of position correction guides includes
an extension portion having:
one end that meets the at least two sides of the housing; and another end
extending in the first direction; and
a bent portion having:
one end configured to meet the other end of the extension portion; and
another end bent to meet a rear of the housing.

13. The self-alignment connector of claim 12, wherein the pair of position correction guides includes:
a first extension portion and a first bent portion formed on a top side of the housing; and
a second extension portion and a second bend portion formed on a bottom side of the housing, respectively.

14. The connector of claim 1, wherein the position correction guides are configured to:
correct a fastening position of the second connector when the first connector and the second connector are fastened with each other; and
distribute a load generated in the first connector.

15. The connector of claim 14, wherein the position correction guides include:
a first extension portion and a first bent portion formed on a top side of the housing; and
a second extension portion and a second bend portion formed on a bottom side of the housing, respectively.

16. The connector of claim 15, wherein the extensions of the position correction guides are configured to prevent movement of the housing in the forward/backward direction.

17. The connector of claim 15, wherein, in response to a load being applied to the first connector in the up-down direction due to a movement of the second connector in the forward and backward directions, the prevention guide is configured to prevent the movement of the first connector in the up-down direction.

18. A self-alignment connector for a vehicle, the connector comprising:
a first connector including a pin terminal; and
a second connector including a socket terminal, the pin terminal insertable in the socket terminal,
wherein the first connector further includes:
a housing for accommodating the pin terminal, the housing including an accommodation space formed therein and configured to accommodate the second connector in a first direction;
position correction guides formed on at least two sides of the housing and configured to extend in the first direction; and
a prevention guide formed at a rear of the housing and configured to extend in a second direction perpendicular to the first direction,
wherein the prevention guide and the position correction guides are configured to correctly align a fastening direction between the first connector and the second connector.
